(19) United States
(12) Patent Application Publication
(10) Pub. No.: US 2010/0225676 A1
(43) Pub. Date: Sep. 9, 2010

(54) INTEGRATED CIRCUIT DEVICE, ELECTRO OPTICAL DEVICE AND ELECTRONIC APPARATUS

(75) Inventor: Motoaki NISHIMURA, Chino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/713,458

(22) Filed: Feb. 26, 2010

(30) Foreign Application Priority Data
Mar. 6, 2009 (JP) 2009-052982

(51) Int. Cl. G06F 3/038; G09G 5/10

(52) U.S. Cl. 345/690; 345/211; 345/89

(57) ABSTRACT

An integrated circuit device includes: a grayscale voltage generation circuit that outputs a plurality of grayscale voltages; and a plurality of driver circuits that drive a plurality of data lines upon receiving the plurality of grayscale voltages, wherein the grayscale voltage generation circuit voltage-divides between a high voltage side power supply voltage and a ground voltage thereby generating the plurality of grayscale voltages, each of the plurality of driver circuits includes a data line driving circuit having a first capacitor and a second capacitor, wherein the data line driving circuit performs an inversion-amplification of a gain according to a capacitor ratio between the first capacitor and the second capacitor, thereby outputting data voltages in an output range whose lower limit voltage is higher than the ground voltage.

The entire disclosure of Japanese Patent Application No. 2009-52982, filed Mar. 6, 2009 is expressly incorporated by reference herein.

### BACKGROUND

1. Technical Field

An aspect of the present invention relates to integrated circuit devices, electro optical devices and electronic apparatuses.

2. Related Art

A driver (an integrated circuit device) for driving a liquid crystal panel (an electro optical panel) includes a grayscale voltage generation circuit that generates grayscale voltages, and outputs data voltages based on the grayscale voltages. For example, such a driver is described in JP-A-2008-107800. Therefore, it is necessary to generate grayscale voltages in a voltage range corresponding to an output voltage range of the data voltages.

For example, when data voltages are outputted by a voltage-follower type data line driving circuit, grayscale voltages in the same voltage range as the output voltage range of the data voltages are generated. However, in this case, the upper limit voltage and the lower limit voltage in the grayscale voltages need to be supplied from an amplifier, and an external stabilization capacitance for stabilizing each of the voltages is necessary.

Furthermore, when grayscale voltages in the same voltage range as the output voltage range of data voltages are to be generated, the power supply to the data line driving circuit also needs to be supplied to the grayscale voltage generation circuit. The power supply may be supplied from, for example, a step-up circuit, and a voltage drop (a voltage reduction) occurs according to the current consumption of the data line driving circuit and the like. In recent years, significant progress has been made in liquid crystal panels with higher definitions, and there has been a tendency to shorten their per-pixel drive time. Therefore, resistance values forming the ladder resistance that generates grayscale voltages need to be made smaller, and the current consumption by the grayscale voltage generation circuit increases due to the lowered resistance values. Consequently, the voltage drop in the output voltage of the step-up circuit also increases, which makes it difficult to secure the output voltage range of the data voltages.

### SUMMARY

In accordance with some embodiments of the invention, it is possible to provide integrated circuit devices, electro optical devices and electronic apparatuses, which can bring the lower limit voltage of grayscale voltages to the ground voltage.

In accordance with an embodiment of the invention, an integrated circuit device includes: a grayscale voltage generation circuit that outputs a plurality of grayscale voltages; and a plurality of driver circuits that drive a plurality of data lines upon receiving the plurality of grayscale voltages, wherein the grayscale voltage generation circuit voltage-divides between a high voltage side power supply voltage and a ground voltage thereby generating the plurality of grayscale voltages, each of the plurality of driver circuits includes a data line driving circuit having a first capacitor and a second capacitor, wherein the data line driving circuit performs an inversion-amplification of a gain according to a capacitor ratio between the first capacitor and the second capacitor, thereby outputting data voltages in an output range whose lower limit voltage is higher than the ground voltage.

According to an aspect of the embodiment of the invention, a power supply circuit outputs a high voltage side power supply voltage, the grayscale voltage generation circuit voltage-divides between the high voltage side power supply voltage and the ground voltage to generate a plurality of grayscale voltages, and the data line driving circuit provided in each of the driver circuits inversion-amplifies a gain according to a capacitor ratio between the first capacitor and the second capacitor, whereby each of the driver circuits outputs data voltages based on the plurality of grayscale voltages to data lines.

According to the above aspect of the embodiment of the invention described above, the grayscale voltage generation circuit voltage-divides between the high voltage side power supply voltage and the ground voltage to generate a plurality of grayscale voltages. Therefore, an amplifier for supplying a low voltage side power supply voltage for the grayscale voltage generation circuit can be omitted, and an external stabilization capacitance for stabilizing an output voltage of that amplifier can be omitted.

In accordance with an aspect of the embodiment of the invention, the data line driving circuit performs an inversion-amplification of a gain according to a capacitance ratio between the first capacitor and the second capacitor. By this, data voltages in an output range whose lower limit voltage is higher than the ground voltage can be outputted based on the plurality of grayscale voltages generated by voltage-dividing between the high voltage side power supply voltage and the ground voltage.

In accordance with an aspect of the embodiment of the invention, the data line driving circuit may have an operational amplifier having a first input terminal whose node is a summing node and an output terminal whose node is an output node, the first capacitor may be provided between an input node of the data line driving circuit and the summing node, and the second capacitor may be provided between the output node and the summing node.

The structure described above can realize a data line driving circuit that performs an inversion amplification of a gain according to a capacitance ratio between the first capacitor and the second capacitor. Specifically, a voltage inputted in the data line driving circuit is supplied to the first capacitor, and a voltage outputted from the operational amplifier is fed back to the second capacitor, whereby an inversion amplification of the gain according to the capacitance ratio thereof can be performed.

Also, in accordance with an aspect of the embodiment of the invention, the data line driving circuit may perform an inversion amplification using an analog reference voltage higher than the ground voltage as a reference.

The structure above makes it possible to realize a data line driving circuit that outputs data voltages in an output range whose lower limit voltage is higher than the ground voltage, based on a plurality of grayscale voltages generated by voltage-dividing between the high voltage side power supply voltage and the ground voltage.

In accordance with an aspect of the embodiment of the invention, the data line driving circuit may output a data voltage VQ=VA−C1/C2×(VIN−VA), where C1 is a capacitance value of the first capacitor, C2 is a capacitance value of the second capacitor, VA is the analog reference voltage, and VIN is an input voltage inputted in the data line driving circuit.

This makes it possible to realize a data line driving circuit that performs an inversion amplification using an analog reference voltage higher than the ground voltage as a reference. Also, the structure above can realize a data line driving circuit that performs an inversion amplification with a gain of −C1/C2 as the gain corresponding to a capacitance ratio between the first capacitor and the second capacitor

In accordance with an aspect of the embodiment of the invention, the analog reference voltage VA may be set at VA=VDDRH/(1+C1/C2), where C1 is a capacitance value of the first capacitor, C2 is a capacitance value of the second capacitor, and VDDRH is the upper limit voltage in the output range of the data voltages that are outputted by the data line driving circuit.

Accordingly, the analog reference voltage VA is set as VA=VDDRH/(1+C1/C2), whereby the analog reference voltage is set at a voltage higher than the ground voltage, and an inversion amplification can be performed using this analog reference voltage as a reference.

In accordance with an aspect of the embodiment of the invention, the high voltage side power supply voltage VDDRW may be set at VDDRW=C2/C1×(VDDRH−VDDRL), where C1 is a capacitance value of the first capacitor, C2 is a capacitance value of the second capacitor, VDDRH is the upper limit voltage and VDDRL is the lower limit voltage in the output range of the data voltages that are outputted by the data line driving circuit, wherein the grayscale voltage generation circuit may generate the plurality of grayscale voltages by voltage-dividing between the high voltage side power supply voltage VDDRW and the ground voltage.

According to the above, the high voltage side power supply voltage VDDRW is set at VDDRW=C2/C1×(VDDRH−VDDRL), whereby data voltages in an output range whose lower limit voltage is VDDRL can be outputted. In this manner, data voltages in an output range whose lower limit voltage is higher than the ground voltage can be outputted.

If a step-up circuit supplies a power supply to the data line driving circuit and to the grayscale voltage generation circuit, when the current consumption by these circuits increases, a voltage drop in the voltage outputted from the step-up circuit increases. When the voltage drop of the step-up circuit increases, the upper limit voltage in an output range of data voltages cannot be secured.

In this respect, in accordance with an aspect of the embodiment of the invention, the C1 and C2 may be C1≧C2.

According to the above aspect of the embodiment, when the C1 and C2 are in a relation of C1≧C2, the output range of data voltages can be made to have a wider voltage range than the voltage range of the plurality of grayscale voltages. By this, the voltage range of the plurality of grayscale voltages can be made to a voltage range whose upper limit voltage is lower than a pre-step-up power supply voltage. In this manner, by supplying the power to the grayscale voltage generation circuit from the pre-step-up power supply, a voltage drop in the voltage to be outputted from the step-up circuit can be mitigated.

In accordance with another aspect of the embodiment of the invention, the data line driving circuit may have a first switch element provided between the input node and a first node, a second switch element provided between the first node and a node of an analog reference voltage, a third switch element provided between the second node and the output node, a fourth switch element provided between the second node and the node of the analog reference voltage, and a fifth switch element provided between the summing node and the output node; the first capacitor may be provided between the first node and the summing node; and the second capacitor may be provided between the summing node and the second node.

This makes it possible to realize a data line driving circuit that includes the operational amplifier, the first capacitor and the second capacitor, and performs an inversion amplification of the gain according to a capacitance ratio between the first capacitor and the second capacitor. The structure described above can also realize an offset-free system that cancels an offset voltage of the operational amplifier and outputs a data voltage that does not depend on an offset voltage of the operational amplifier.

Another embodiment of the invention pertains to an electro optical device that includes any one of the integrated circuit devices described above.

Still another embodiment of the invention pertains to an electronic apparatus that includes any one of the integrated circuit devices described above.

### BRIEF DESCRIPTION OF THE DRAWINGS

FIGS. 1A and 1B show a comparison example of an integrated circuit device.

FIG. 2 shows an exemplary composition of an integrated circuit device in accordance with an embodiment of the invention.

FIG. 3 is a diagram for describing an exemplary operation of the present embodiment.

FIG. 4 is a diagram for describing an exemplary operation of the present embodiment.

FIG. 5 shows a detailed exemplary composition of a data line driving circuit.

FIG. 6 shows a detailed exemplary composition of the data line driving circuit.

FIGS. 7A-7C show an exemplary principle composition of a data line driving circuit.

FIG. 8 is an exemplary composition of an electro optical device.

FIG. 9 is an exemplary composition of a data driver.

FIGS. 10A and 10B show exemplary compositions of electronic apparatuses.

### DESCRIPTION OF EXEMPLARY EMBODIMENTS

Preferred embodiments of the invention are described in detail below. It is noted that the embodiments described below should not unduly limit the content of the invention recited in the scope of the claimed invention, and all of the compositions to be described in the embodiments may not necessarily be indispensable as means for solution provided by the invention.

### 1. Comparison Example

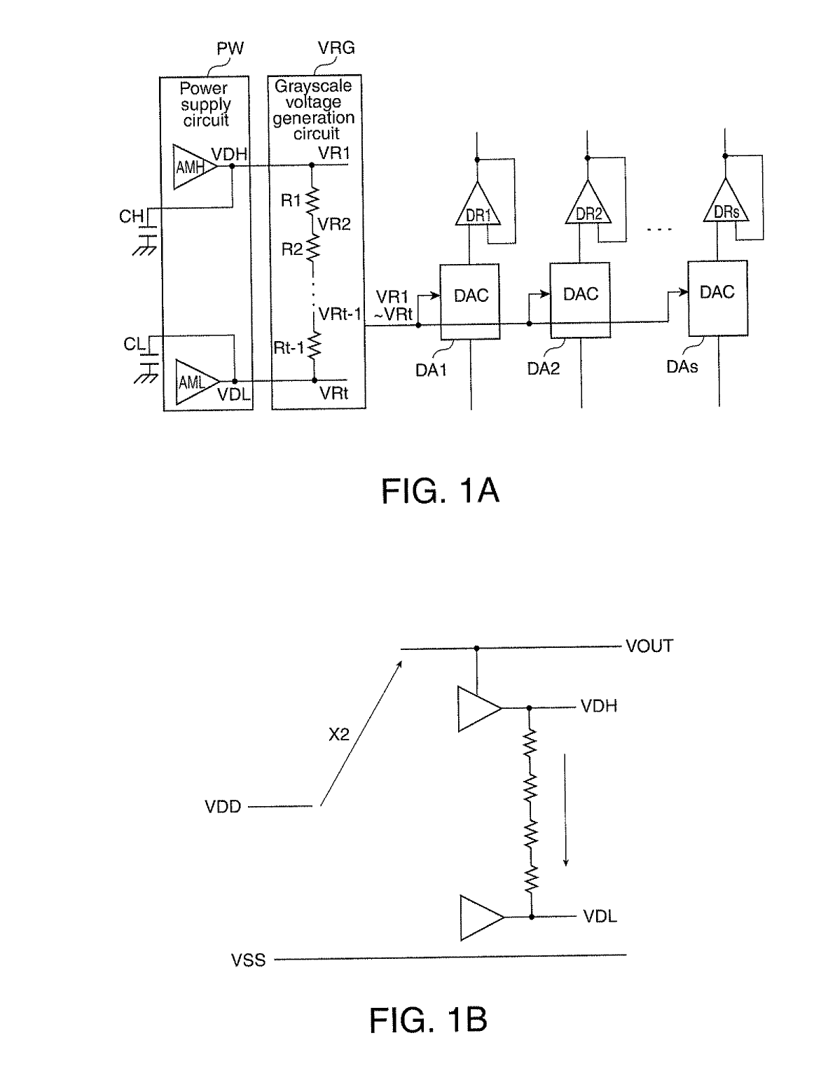

Referring to FIGS. 1A and 1B, an example for comparison with an embodiment of the invention will be described. FIG. 1A shows a comparison example of a driver (an integrated circuit device) that drives a liquid crystal panel (an electro optical panel, an electro optical device), as an example for comparison with the present embodiment. The driver of the comparison example includes a power supply circuit PW, a grayscale voltage generation circuit VRG, D/A converter circuits DA1-DAs (s is a natural number), and data line driving circuits DR1-DRs.

Specifically, the power supply circuit PW includes amplifiers AMH and AML. The amplifier AMH outputs a voltage VDH, and the amplifier AML outputs a voltage VDL. A node of the VDH is connected to a stabilization capacitance CH for stabilizing the VDH (for keeping the voltage value constant). Similarly, a node of the VDL is connected to a stabilization capacitance CL. The capacitances CH and CL are mounted externally to the driver. The grayscale voltage generation circuit VRG voltage-divides between the power supply voltages VDH and VDL with ladder resistances R1-Rₜ₋₁ (t is a natural number of 2 or greater), and outputs grayscale voltages VR1-VRt generated by the voltage division. The D/A converter circuits DA1-DAs D-to-A convert image data based on the grayscale voltages VR1-VRt, and output output-voltages generated through the D/A conversion. Then, the data line driving circuits DR1-DRs buffer the output voltages from the D/A converter circuits DA1-DAs, and output the data voltages. The data line driving circuits DA1-DAs are formed with operational amplifiers each being connected in a voltage-follower configuration.

In this manner, with the comparison example shown in FIG. 1A, output voltages from the D/A converter circuits DA1-DAs are buffered by the operational amplifiers each connected in a voltage-follower configuration, and then outputted as data voltages. For this reason, the output voltage range of the data voltages is the same as the voltage range of the grayscale voltages VR1-VRt that range between VDL and VDH. The output voltage range of data voltages is limited within the range of voltages that can be outputted by the data line driving circuits DR1-DRs, such that the lower limit voltage VDL is generally higher than the ground voltage VSS. In the comparison example shown in FIG. 1A, the amplifier AML and the external stabilizing capacitance CL are provided for generating the VDL. In this manner, when voltage-follower type data line driving circuits are used, an external stabilizing capacitance CL is necessary.

In the case of a battery-operated electronic apparatus such as a portable telephone, the power supply voltage is stepped up in order to obtain drive voltages for its liquid crystal panel. For example, as shown in FIG. 1B, the system power supply voltage VDD is stepped up by two times by a step-up circuit built in the driver, and a voltage VOUT obtained by the step-up operation is supplied to the data line driving circuit and the grayscale voltage generation circuit. In this instance, the current consumed by the data line driving circuit and the grayscale voltage generation circuit becomes a load current of the step-up circuit. As the step-up circuit has a step-up impedance (an output impedance), the load current causes a voltage drop (a voltage reduction) in the output voltage VOUT. If the voltage drop causes the VOUT to become lower than the VDH, the output range of data voltages cannot be secured.

For example, the per-pixel drive time has been shortened due to the greater demand for higher definitions in recent years. In order to match with the shortened drive time, the time constant (the time constant at which an output of the D/A converter circuit becomes asymptotic to a desired grayscale voltage) is made smaller by lowering the resistance of the ladder resistances R1-Rₜ₋₁. Then the current consumption by the grayscale voltage generation circuit increases, and the voltage drop in the output voltage VOUT of the step-up circuit also increases. In this manner, as the consumed current of the grayscale voltage generation circuit becomes a load current of the step-up circuit, the output range of data voltages becomes difficult to be secured.

### 2. Integrated Circuit Device

### 2.1. Composition Example

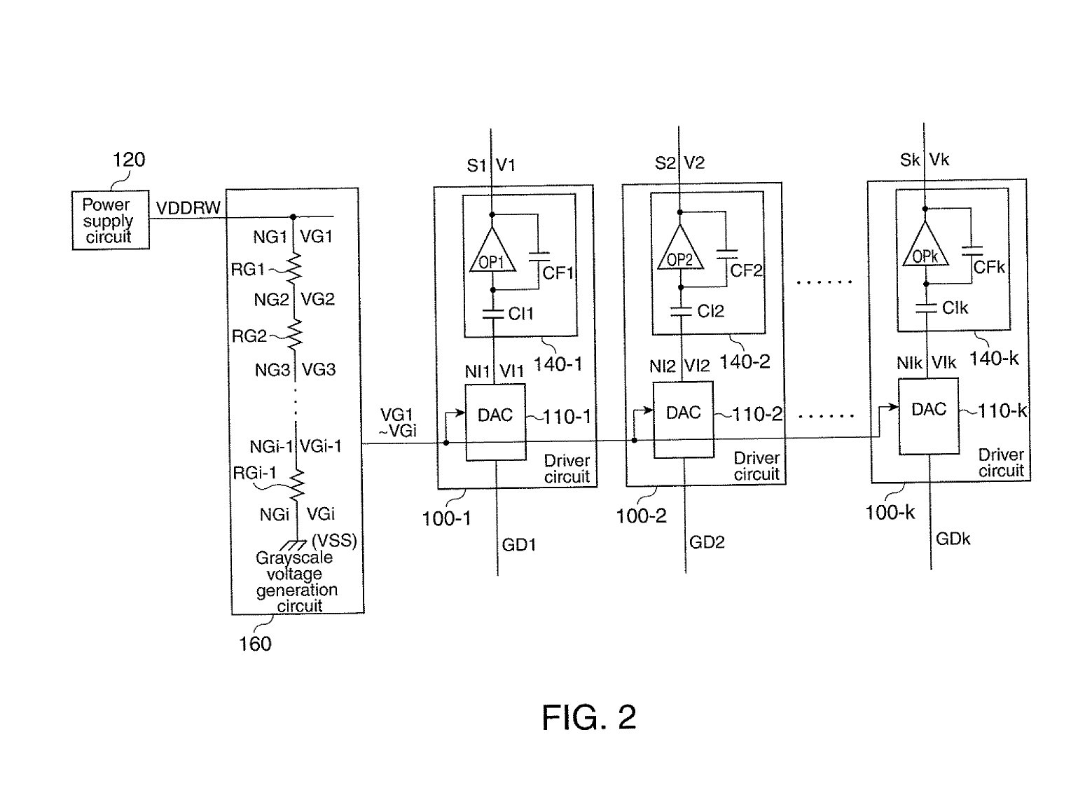

FIG. 2 shows an exemplary composition of an integrated circuit device in accordance with an embodiment of the invention to address the problems described above. The exemplary composition shown in FIG. 2 includes first-k-th driver circuits 100-1-100-k (a plurality of driver circuits: k is a natural number), a power supply circuit 120, and a grayscale voltage generation circuit 160 (a reference voltage generation circuit). The exemplary composition pertains to a circuit that voltage-divides between a high voltage side power supply voltage VDDRW and a ground voltage VSS to generate first-i-th grayscale voltages VG1-VGi (i is a natural number of 2 or greater), and outputs data voltages V1-Vk based on the grayscale voltage VG1-VGi.

Specifically, the power supply circuit 120 generates the high voltage side power supply voltage VDDRW and supplies the voltage VDDRW to the grayscale voltage generation circuit 160. For example, the power supply circuit 120 may resistance-divide between a power supply voltage VDD (a first power supply voltage) and the ground voltage VSS (a second power supply voltage) to output the voltage VDDRW, buffer the voltage VDDRW with a voltage-follower and supply the same to the grayscale voltage generation circuit 160. Alternatively, the power supply circuit 120 may include a step-up circuit that steps up the power supply voltage VDD to output a voltage VOUT. Then, the power supply circuit 120 may resistance-divide between the voltage VOUT and the ground voltage VSS to output a voltage VDDRW, buffer the voltage VDDRW with a voltage-follower and supply the same to the grayscale voltage generation circuit 160.

The grayscale voltage generation circuit 160 receives the voltage VDDRW from the power supply circuit 120, and outputs grayscale voltages VG1-VGi to the driver circuits 100-1-100-k. Specifically, the grayscale voltage generation circuit 160 resistance-divides (voltage-divides) between the voltage VDDRW and the ground voltage VSS with first-(i−1)-th resistance elements RG1-RGᵢ₋₁. Then the grayscale voltage generation circuit 160 outputs grayscale voltages VG1-VGi generated through the resistance-division to first-i-th grayscale voltage nodes NG1-NGi. More specifically, the resistance elements RG1-RGᵢ₋₁ are provided in series between the node NG1 (the node of the voltage VDDRW) and the node NGi (the node of the ground voltage VSS). In other words, the RG1 is provided between the NG1 and the NG2, and the RG2 is provided between the NG2 and the NG3. Further, the RGᵢ₋₁ is provided between the NGᵢ₋₁ and the NGi. It is noted that another resistance element such as a variable resistance or the like, a transistor for turning on/off the grayscale voltages and the like may be provided between the output of the power supply circuit 120 (the node of the voltage VDDRW) and the resistance element RG1.

The driver circuits 100-1-100-k receive the grayscale voltages VG1-VGi and first-k-th image data GD1-GDk (grayscale data), and outputs first-k-th data voltages V1-Vk (source voltages). Specifically, the driver circuits 100-1-100-k include D/A converter circuits 110-1-110-k (DACs: Digital to Analog Converters, or data voltage generation circuits in a broad sense) and data line driving circuits 140-1-140-k (source line driving circuits), respectively.

The D/A converter circuits 110-1-110-k receive image data GD1-GDk, D/A convert the image data GD1-GDk, and output voltages VI1-VIk generated through the D/A conversion. The D/A converter circuits 110-1-110-k select, among the grayscale voltages VG1-VGi, grayscale voltages corresponding to the image data GD1-GDk, thereby D/A converting the image data GD1-GDk.

The data line driving circuit 140-1-140-k receive the first-th k-th input voltages VI1-VIk from the D/A converter circuits 110-1-110-k, and output data voltages V1-Vk to first-k-th data lines S1-Sk (a plurality of data lines). Specifically, the data line driving circuits 140-1-140-k include operational amplifiers OP1-OPk, input capacitors CI1-CIk (first capacitors) and feedback capacitors CF1-CFk (second capacitors), respectively. The data line driving circuits 140-1-140-k inversion-amplify the input voltages VI1-VIk with gains (for example, a gain equal to a capacitance ratio CI1/CF1) corresponding to capacitance ratios (for example, CI1/CF1) between the input capacitors CI1-CIk and the feedback capacitors CF1-CFk, respectively.

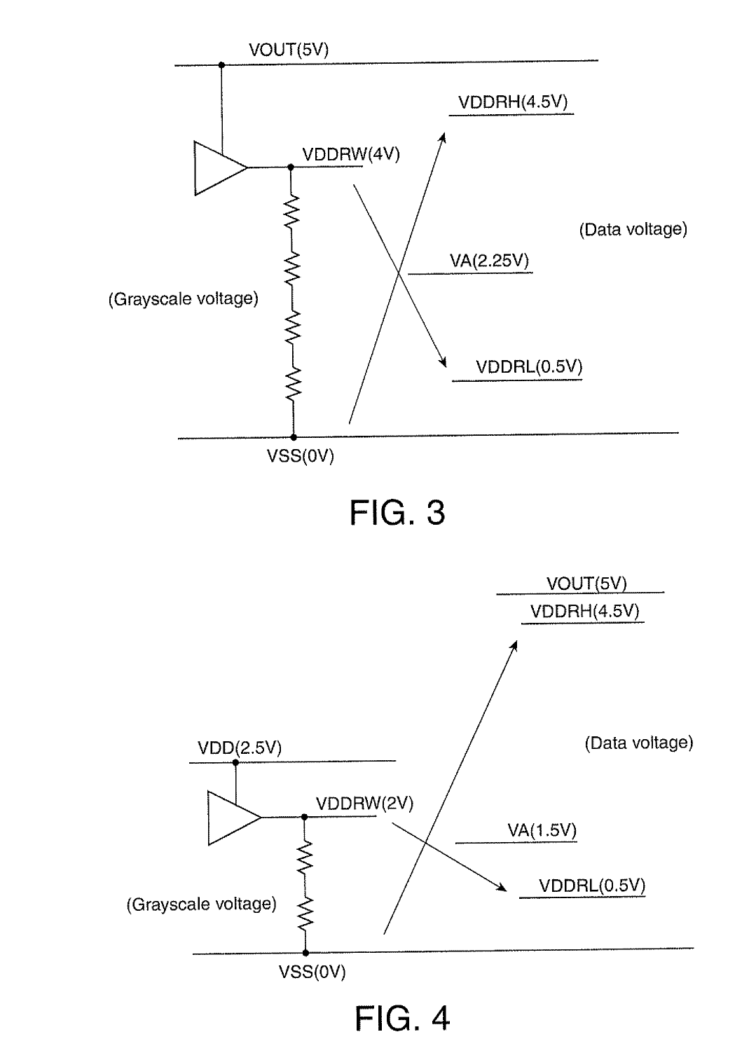

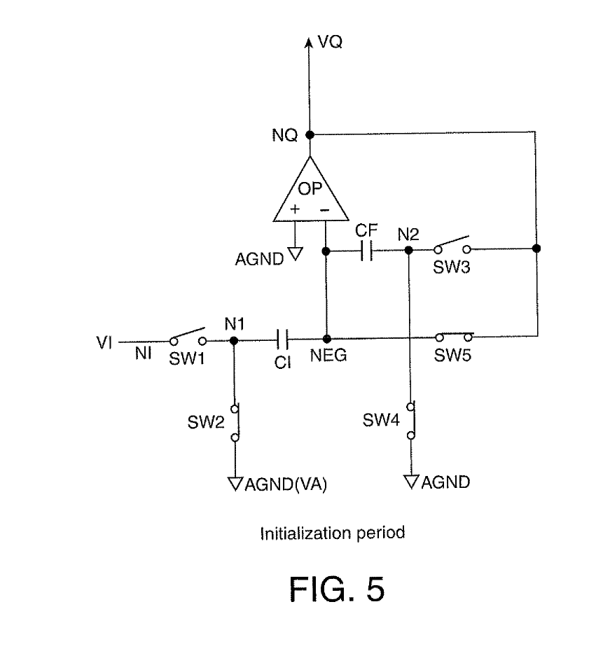

More specifically, inverting input terminals (first input terminals) of the operational amplifiers OP1-OPk are connected to summing nodes NEG1-NEGk, (reference nodes). Non-inverting input terminals (forward input terminals, second input terminals) of the operational amplifiers OP1-OPk are supplied with, for example, an analog reference voltage VA from the power supply circuit 120 (for example, VA=VDDRH/2 to be described below in conjunction with FIG. 3). The capacitors CF1-CFk are provided between the output nodes of the operational amplifiers OP1-OPk (i.e., nodes of the output terminals) and the summing nodes NEG1-NEGk, respectively. The capacitors CI1-CIk are provided between the first-k-th input nodes NI1-NIk of the data line driving circuits 140-1-140-k and the summing nodes NEG1-NEGk, respectively. Input voltages VI1-VIk from the D/A converter circuits 110-1-110-k are inputted in the capacitors CI1-CIk, respectively. Then the operational amplifiers OP1-OPk output data voltages V1-Vk to the respective output nodes. For example, the data line driving circuits 140-1-140-k may be composed of data line driving circuits shown in FIG. 5 to be described below.

### 2.2. Operation Example

As described above, the comparison example shown in FIG. 1A uses the amplifier AML for generating a lower voltage side power supply voltage VDL of the grayscale voltage generation circuit. For this reason, the external stabilization capacitance CL needs to be provided for stabilizing the output voltage VDL of the amplifier AML. Also, in the comparison example, the current consumed by the grayscale voltage generation circuit becomes to be a load current of the step-up circuit. Accordingly, this poses a problem in that, when the current consumption by the grayscale voltage generation circuit increases, a voltage drop in the output voltage VOUT of the step-up circuit is also increased.

In contrast, in accordance with the present embodiment, the power supply circuit 120 outputs a high voltage side power supply voltage VDDRW, the grayscale voltage generation circuit 160 voltage-divides between the voltage VDDRW and the ground voltage VSS to generate grayscale voltages VG1-VGi, the data line driving circuits 140-1-140-k perform inversion-amplification of gains according to capacitance ratios between the input capacitors CI1-CIk and the feedback capacitors CF1-CFk, respectively, and the driver circuits 100-1-100-k output data voltages V1-Vk based on the grayscale voltages VG1-VGi, respectively.

In this manner, according to the present embodiment, the grayscale voltage generation circuit 160 voltage-divides between the voltage VDDRW and the ground voltage VSS to generate grayscale voltages VG1-VGi. Therefore, the amplifier for supplying a low voltage side power supply voltage to the grayscale voltage generation circuit and the external stabilization capacitance can be omitted. As a result, the number of external components can be reduced, whereby cost reduction and mounting area reduction can be realized.

Also, according to the present embodiment, the data line driving circuits 140-1-140-k inversion-amplify gains according to capacitance ratios between the capacitors CI1-CIk and the capacitors CF1-CFk, respectively. By this, the data line driving circuits 140-1-140-k can output data voltages in an output range whose lower limit voltage is higher than the ground voltage VSS. For example, as shown in FIG. 3, as the data line driving circuits 140-1-140-k perform inversion-amplification, the VDDRW (for example, 4V) is outputted as the lower limit voltage VDDRL (0.5V) in the data voltages, and the VSS (0V) is outputted as the upper limit voltage VDDRH (4.5V) in the data voltages. In this manner, based on the grayscale voltages VG1-VGi generated by voltage-dividing between the voltage VDDRW and the ground voltage VSS, data voltages in an output range whose lower limit voltage is higher than the ground voltage VSS can be outputted.

According to the present embodiment, the data line driving circuits 140-1-140-k may have operational amplifiers OP1-OPk, and inverting input terminals of the operational amplifiers OP1-OPk may be summing nodes NEG1-NEGk, and output terminals of the operational amplifiers OP1-OPk may be output nodes. Further, the capacitors CI1-CIk may be provided between the input nodes NI1-NIk of the data line driving circuits 140-1-140-k and the summing nodes NEG1-NEGk, respectively, and the capacitors CF1-CFk may be provided between the output nodes and the summing nodes NEG1-NEGk, respectively.

Consequently, the structure above can realize data line driving circuits that inversion-amplify gains according to capacitance ratios between the capacitors CI1-CIk and the capacitors CF1-CFk, respectively. Specifically, input voltages VI1-VIk are inputted in the capacitors CI1-CIk, and the capacitors CF1-CFk feedback output voltages V1-Vk, whereby inversion-amplification of the gains according to the capacitance ratios CI1/CF1-CIk/CFk can be performed.

Also, according to the present embodiment, the data line driving circuits 140-1-140-k may perform inversion-amplification with an analog reference voltage VA as a reference that is higher than the ground voltage VSS.

This makes it possible to realize data line driving circuits that output data voltages in an output range whose lower limit voltage is higher than the ground voltage VSS. For example, as shown in FIG. 3, grayscale voltages VSS-VDDRW being 0V-4V may be inversion-amplified (multiplied by −1) with the VA being 2.25 V as a reference, data voltages in a voltage range of VDDRL VDDRH being 0.5V-4.5V can be outputted.

Further, according to the present embodiment, when the capacitance value of the input capacitor is C1, the capacitance value of the feedback capacitor is C2, the input voltage of the data line driving circuit is VIN, and the data voltage is VQ, the data line driving circuits 140-1-140-k may output data voltages VQ shown in the following formula (1).

VQ=VA−C1/C2×(VIN−VA) (1)

In this manner, with the analog reference voltage VA that is higher than the ground voltage VSS as a reference, the input voltages VI1-VIk of the data line driving circuits 140-1-140-k can be inversion-amplified. Also, inversion-amplification of the gains according to the capacitance ratios between the input capacitors CI1-CIk and the feedback capacitors CF1-CFk can be performed. For example, as shown in FIG. 3, when C1/C2=1 and VA=2.25V, VIN=VDDRW=4V is multiplied by −C1/C2=−1 with the VA=2.25V as a reference, whereby VQ=VDDRL=0.5V is outputted.

Also, according to the present embodiment, when the upper limit voltage in the output range of data voltages is VDDRH, the analog reference voltage may be set at VA shown in the following formula (2).

VA=VDDRH/(1+C1/C2) (2)

In this manner, the analog reference voltage VA is set to be higher than the ground voltage VSS, and inversion-amplification can be performed with the VA as a reference. For example, in FIG. 3, by setting VA=4.5V/(1+1)=2.25V, inversion-amplification can be performed with the VA=2.25V as a reference, as described above. Also, in accordance with the present embodiment, based on the grayscale voltages VG1-VGi generated by voltage-dividing between the voltage VDDRW and the ground voltage VSS, data voltages whose upper limit voltage is VDDRH can be outputted. In other words, the following formula (3) is established based on the formula (1) and the formula (2) described above, whereby VQ=VDDRH is outputted when VIN=VSS=0V.

VQ=VDDRH−C1/C2×VIN (3)

In accordance with the present embodiment, when the lower limit voltage in the output range of data voltages is VDDRL, the high voltage side power supply voltage is set at VDDRW shown in the following formula (4), and the grayscale voltage generation circuit 160 may voltage-divide between the voltage VDDRW and the ground voltage VSS to generate grayscale voltages VG1-VGi.

VDDRW=C2/C1×(VDDRH−VDDRL) (4)

Accordingly, based on the grayscale voltages VG1-VGi generated by voltage-dividing between the voltage VDDRW and the ground voltage VSS, data voltages whose lower limit voltage is VDDRL can be outputted. Specifically, based on the formulas (3) and (4) above, VQ=VDDRL is outputted when VIN=VDDRW, whereby data voltages whose lower limit voltage is VDDRL can be outputted.

Also, in accordance with the present embodiment, the C1 and the C2 may be C1≧C2.

By so doing, the output range of data voltages between VDDRL and VDDRH can be made wider than the voltage range of the grayscale voltages VG1-VGi that range between VSS and VDDRW. By this, the grayscale voltages VG1-VGi can be generated without causing the current consumed by the grayscale voltage generation circuit 160 to become a load current of the step-up circuit.

The above will be more concretely described with reference to FIG. 4. FIG. 4 shows an operation example in accordance with an embodiment of the invention when C1/C2=2. As shown in FIG. 4, when the output range of data voltages VDDRL-VDDRH=0.5V-4.5V, VA=1.5V is set by the above formula (2), and VDDRW=2V is set by the above formula (4). In this instance, as shown in FIG. 4, when VDD=2.5V is stepped up by two times to generate VOUT=5V, VDDRW can be set to a lower voltage than VDD for the output range of data voltages VDDRL-VDDRH. By this, the voltage VDDRW can be generated using the power supply voltage VDD. In this manner, according to the present embodiment, by setting C1≧C2, the grayscale voltages VG1-VGi can be generated without causing the current consumed by the grayscale voltage generation circuit 160 to become a load current of the step-up circuit. Accordingly, the load current of the step-up circuit can be reduced, and the voltage drop in the output voltage VOUT of the step-up circuit can be mitigated.

### 3. Data Line Driving Circuit

FIG. 5 shows a detailed exemplary composition of a data line driving circuit. The data line driving circuit shown in FIG. 5 includes an operational amplifier OP, an input capacitor CI, a feedback capacitor CF, and first-fifth switch elements SW1-SW5. The data line driving circuit receives an input voltage VI and outputs an output voltage VQ, thereby driving data lines.

Specifically, the capacitor CI is provided between a summing node NEG (a reference node, a negative node, an inverting input terminal node, a charge storing node) and a first node N1. The capacitor CF is provided between the summing node NEG and a second node N2. Each of the capacitors CI and CF can be made of, for example, a plurality of unit capacitors.

The switch element SW1 is provided between the node N1 and an input node NI. The switch element SW2 is provided between the node N1 and AGND (a node of an analog reference voltage VA, or an analog reference power supply in a broad sense). The switch element SW3 is provided between the node N2 and an output node NQ. The switch element SW4 is provided between the node N2 and AGND. The switch element SW5 is provided between the summing node NEG and the output node NQ.

The switch elements SW1-SW5 may be composed of, for example, CMOS transistors. Specifically, they may be formed from transfer gates composed of P type transistors and N type transistors. These transistors are switched on/off by switching control signals from an unshown switching control signal generation circuit.

The operational amplifier OP has an inverting input terminal (a first input terminal in a broad sense) connected to the summing node NEG, and a non-inverting input terminal (a second input terminal in a broader sense) connected to AGND, and outputs an output voltage VQ to the output node NQ (a node of the output terminal).

As shown in FIG. 5, in the data line driving circuit of the detailed exemplary embodiment, the switch elements SW2, SW4 and SW5 turn on in an initialization period (a period in which an initialization voltage is set at the CI and CF).

As the switch element SW2 turns on in the initialization period, one end of the capacitor CI with its other end electrically connected to the summing node NEG is set at AGND (an analog reference voltage VA). Likewise, when the switch element SW4 turns on, one end of the capacitor CF with its other end electrically connected to the summing node NEG is set at AGND (VA). Also, when the switch element SW5 that is a feedback switch element turns on, an output of the operational amplifier OP is fed back to the inverting input terminal, whereby the node NEG is set at AGND by an imaginary short function of the operational amplifier OP.

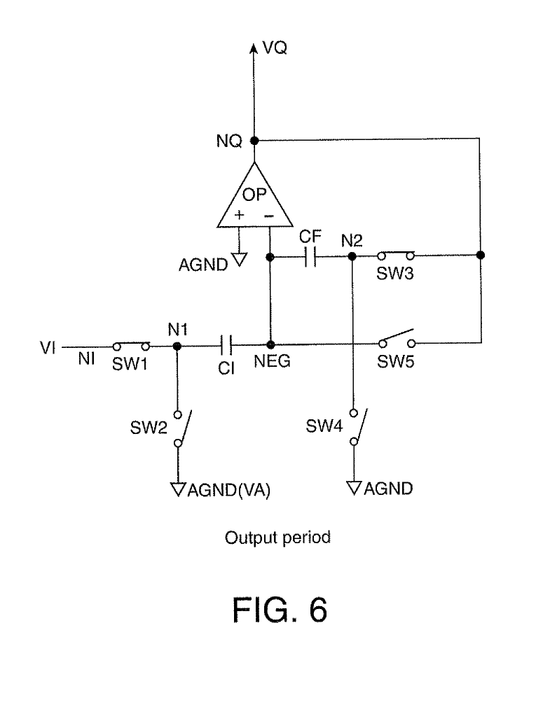

Further, as shown in FIG. 6, in the data line driving circuit of the detailed exemplary embodiment, the switch elements SW1 and SW3 turn on in an output period (a period in which an output voltage is outputted to drive a driving target).

As the switch element SW1 turns on in the output period, one end of the capacitor CI with its other end connected to the summing node NEG is set at the input voltage VI. Also, when the switch element SW3 turns on, one end of the capacitor CF with its other end connected to the summing node NEG is set at the output voltage VQ (an output of the OP).

According to the data line driving circuit of the detailed exemplary embodiment, it is possible to realize a data line driving circuit having an operational amplifier, an input capacitor and a feedback capacitor, which inversion-amplifies the gain according to a capacitance ratio between the input capacitor and the feedback capacitor.

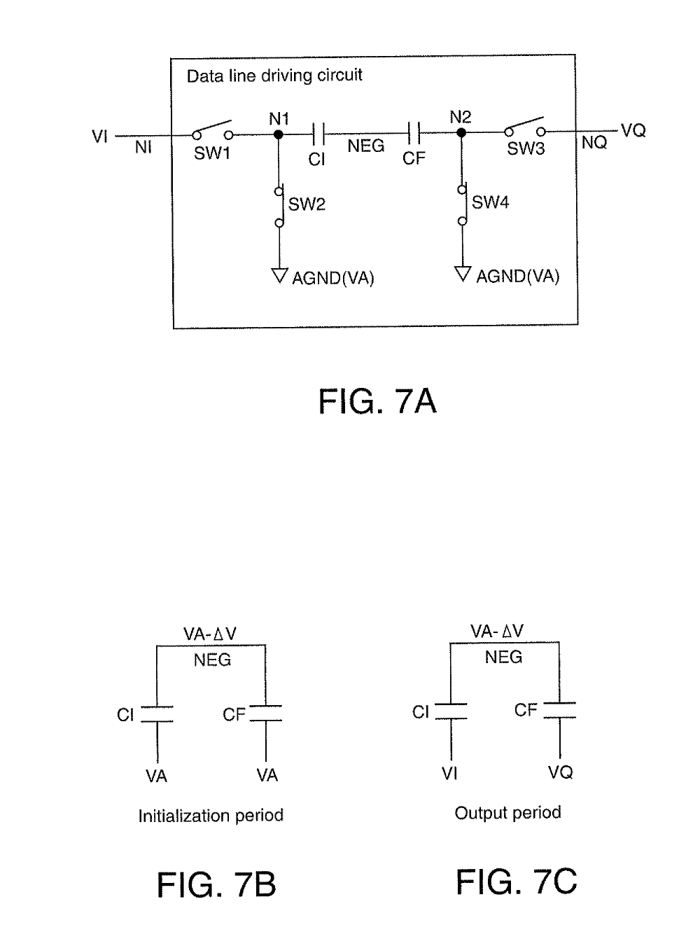

FIG. 7A shows a principle composition of a data line driving circuit in accordance with the detailed exemplary composition. As shown in FIG. 7A, the data line driving circuit in accordance of the detailed exemplary composition needs only to include the capacitors CI and CF. It is sufficient if one end of the CI is connected to the summing node NEG, and the other end is set at the analog reference voltage VA in the initialization period and at the input voltage VI in the output period. Also it is sufficient if one end of the CF is connected to the summing node NEG, and the other end is set at the analog reference voltage VA in the initialization period and at the output voltage VQ in the output period.

It is also sufficient if the summing node NEG (a connection node of the CI and the CF) is a node that is set at a given voltage (for example, VA, VA-ΔV) in the initialization period, and is set in the output period at the same potential as that in the initialization period in a high impedance state (a floating state). To realize such functions of the node NEG, the example shown in FIG. 5 and FIG. 6 uses the operational amplifier OP. However, such functions may be realized by a circuit other than the operational amplifier OP.

Next, referring to FIGS. 78 and 7C, the relation between the input voltage VI and the output voltage VQ in the data line driving circuit of the detailed exemplary composition will be described.

As shown in FIG. 7B, in the initialization period, one ends of the capacitors CI and CF are set at VA, and the other ends thereof are set at VA-ΔV. It is noted that ΔV is an offset voltage (an input referred offset voltage) of the operational amplifier OP.

On the other hand, as shown in FIG. 7C, in the initialization period, one end of the capacitor CI is set at VI and the other end thereof at VA-ΔV, and one end of the capacitor CF is set at VQ, and the other end thereof is set at VA-ΔV. Accordingly, the following formula (5) is established according to the law of charge conservation.

CI×{VA−(VA−ΔV)}+CF×{VA−(VA−ΔV)}=CI×{VI−(VA−ΔV)}+CF×{VQ−(VA−ΔV)} (5)

Accordingly, the following formula (6) is established.

VQ=VA−(CI/CF)×(VI−VA) (6)

As is clear from the formula (6) above, the offset voltage ΔV does not appear as the output voltage VQ, whereby so-called offset-free can be realized.

### 4. Electro Optical Device

### 4.1. Composition Example

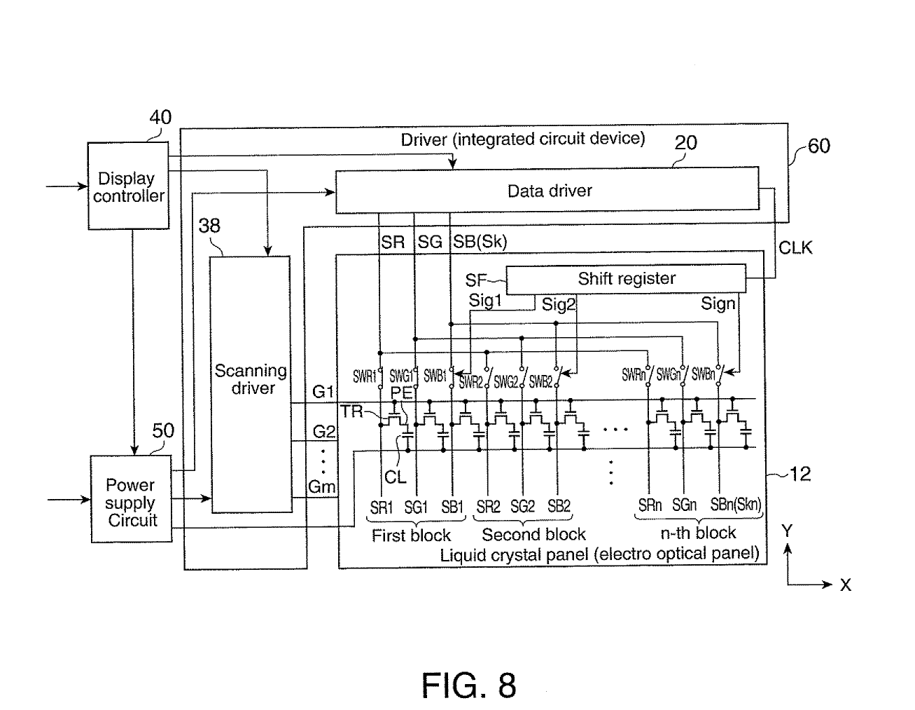

FIG. 8 shows an exemplary composition of an electro optical device to which the integrated circuit device in accordance with an embodiment of the invention is applicable. FIG. 8 illustrates an exemplary composition of a liquid crystal display device using a liquid crystal panel, as an exemplary composition of an electro optical device. However, the invention is also applicable to electro optical devices that use electro optical panels other than liquid crystal panels. Also, the invention is applicable to electro optical devices other than electro optical panels. For example, the invention is also applicable to electro optical devices using electro luminescence (EL) panels that use self-luminous elements such as organic EL elements, inorganic EL elements, and the like, as well as to electro optical devices using electrophoretic panels (electrophoretic displays).

The exemplary composition of the liquid crystal display device (an electro optical device in a broad sense) shown in FIG. 8 includes a liquid crystal panel 12 (an electro optical panel in a broad sense), a driver 60 (an integrated circuit device in a broad sense), a display controller 40, and a power supply circuit 50. According to the embodiment of the invention, it is not necessary to include all of the circuit blocks described above in the liquid crystal display device, and a part of the circuit blocks may be omitted from the liquid crystal display device.

The liquid crystal panel 12 (LCD: Liquid Crystal Display) may be comprised of, for example, an active matrix type panel, a simple matrix type panel or the like. For example, in the case of an active matrix type panel, the liquid crystal panel 12 is formed on an active matrix substrate (for example, a glass substrate). On the active matrix substrate is arranged a plurality of scanning lines G1-Gm (m is a natural number of 2 or greater) extending in the X direction in FIG. 8, and a plurality of data lines SR1, SG1, SB1, . . . , SRn, SGn, SBn (n is a natural number of 2 or greater) extending in the Y direction in FIG. 8. Also, the active matrix substrate is provided with switch elements SWR1, SWG1, SWB1, . . . , SWRn, SWGn, SWBn corresponding to the respective data lines, a shift register SF, and data voltage supply lines SR, SG and SB (source voltage supply lines).

A thin film transistor (TFT, a switching element in a broad sense) and a liquid crystal capacitance (a liquid crystal element, an electro optical element in a broad sense) are provided at a position corresponding to each one of the intersections of the scanning lines and the data lines. For example, a thin film transistor TR and a liquid crystal capacitance CL are provided at a position corresponding to an intersection between the scanning line G1 and the data line SR1. The TR has a gate electrode connected to the scanning line G1, a source electrode connected to the data line SR1, and a drain electrode connected to a pixel electrode PE. The liquid crystal capacitance CL is formed between the pixel electrode PE and a counter electrode CE (a shared electrode, a common electrode). The counter electrode CE is formed on a counter substrate opposite to the active matrix substrate, and liquid crystal (electro optical substance in a broad sense) is contained in a space between the active matrix substrate and the counter substrate.

Here, it is assumed that the data lines SR1, SG1, SB1, . . . , SRn, SGn, SBn are divided into blocks (divided into groups, sections) of first block (SR1, SG1 and SB1)-n-th block (SRn, SGn and SBn). The liquid crystal panel 12 is driven by a scanning drive method in which the first-n-th blocks of data lines are sequentially driven.

Specifically, the switch elements SWR1, SWG1, SWB1, . . . , SWRn, SWGn, SWBn divide grayscale voltages supplied by time division onto the data voltage supply lines SR, SG and SB, and supply the same to the first-n-th blocks of data lines.

The shift register SF outputs control signals for on/off controlling the switch elements SWR1, SWG1, SWB1, . . . , SWRn, SWGn, SWBn. The shift register SF receives a scanning drive clock signal from the data driver 20, and sequentially makes the control signals Sig1-Sign to be active (at a first logical level).

Then, when the control signal Sig1 is made active, the switch elements SWR1, SWG1 and SWB1 turn on, whereby the data lines SR1, SG1 and SB1 of the first block are driven. When the control signal Sig2 is made active, the switch elements SWR2, SWG2 and SWB2 turn on, whereby the data lines SR2, SG2 and SB2 of the second block are driven. When the control signal Sign is made active, the switch elements SWRn, SWGn and SWBn turn on, whereby the data lines SRn, SGn and SBn of the n-th block are driven. In this manner, the data lines in the first-n-th blocks are sequentially driven, whereby the scanning driven is performed.

It is noted that the switch elements SWR1, SWG1, SWB1, . . . , SWRn, SWGn, SWBn, and the shift register SF may be formed with, for example, thin film transistors TFT.

The driver 60 includes a data driver 20 (a source driver) and a scanning driver 38 (a gate driver). The data driver 20 drives the data lines SR1, SG1, SB1, . . . , SRn, SGn, SBn based on the grayscale data (image data). The scanning driver 38 scans (sequentially drives) the scanning lines G1-Gm of the liquid crystal panel 12. It is noted that, when the integrated circuit device of the present embodiment is applied to the driver 60, data line driving circuits (for example, data line driving circuits 140-1-140-k shown in FIG. 2) drive the data lines SR1, SG1, SB1, . . . , SRn, SGn, SBn through the data voltage supply lines SR, SG and SB.

The display controller 40 controls the data driver 20, the scanning driver 38 and the power supply circuit 50 according to the contents set by a host controller such as an unshown central processing unit (CPU) or the like. Specifically, the display controller 40 sets operation modes and supplies vertical synchronization signals and horizontal synchronization signals that are generated within to the data driver 20 and the scanning driver 38, for example. Further, the display controller 40 controls the voltage level of a counter electrode voltage VCOM to be applied to the counter electrode CE, for example.

The power supply circuit 50 generates a variety of voltage levels necessary for driving the display panel 12, and the voltage level of the counter electrode voltage VCOM for the counter electrode CE. For example, a grayscale voltage generation circuit may be built in the data driver 20, and the power supply circuit 50 can generate voltage levels of the power supply voltages for the grayscale voltage generation circuit.

It is noted that the data driver 20 may perform a polarity inversion drive of the liquid crystal panel 12. In this instance, the grayscale voltage generation circuit may include grayscale voltage generation circuits for the positive polarity and the negative polarity. Alternatively, a high voltage side power supply voltage and a low voltage side power supply voltage of the grayscale voltage generation circuit may be alternately switched to generate grayscale voltages for the positive polarity and the negative polarity.

The example shown in FIG. 8 is described assuming that the data driver 20 sequentially drives groups of three data lines each for RGB colors through the data voltage supply lines SR, SG and SB. However, according to the embodiment of the invention, the data driver 20 may sequentially drive groups of k-number of data lines each through the data voltage supply lines S1-Sk (k is a natural number of 2 or greater).

Also, in FIG. 8, the display controller 40 and the power supply circuit 50 are provided inside a liquid crystal display device 10. However, in accordance with the embodiment of the invention, the display controller 40 and the power supply circuit 50 may be provided outside the liquid crystal display device 10. Moreover, all or a portion of the data driver 20, the scanning driver 38, the display controller 40 and the power supply circuit 50 may be formed on the display panel 12. Further, all or a portion of the data driver 20, the scanning driver 38, the display controller 40 and the power supply circuit 50 may be formed into a semiconductor device (an integrated circuit, an IC).

### 4.2. Data Driver

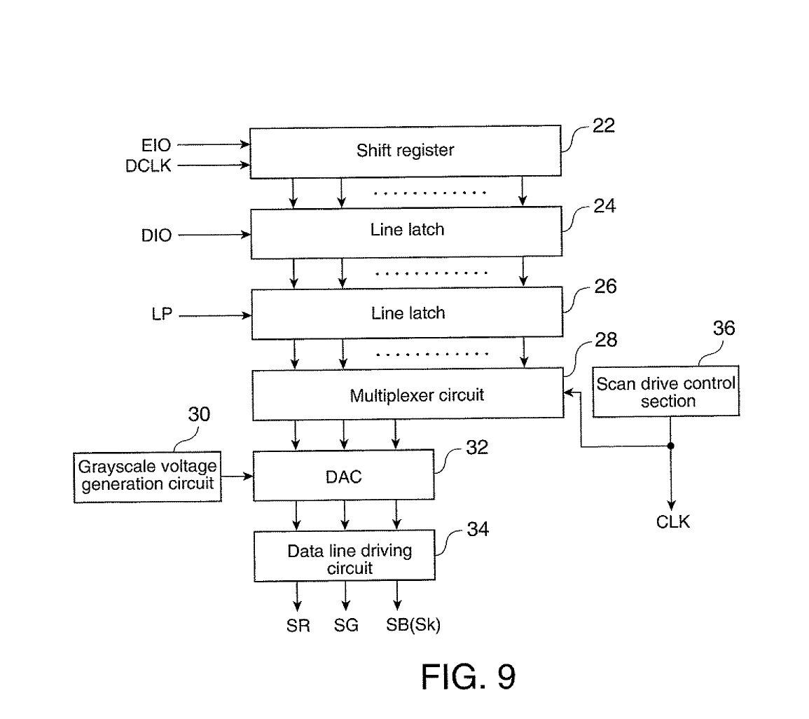

FIG. 9 shows an exemplary composition of the data driver 20. The exemplary composition includes a shift register 22, line latches 24, 26, a multiplexer circuit 28, a grayscale voltage generation circuit 30 (a reference voltage generation circuit), a DAC 32 (digital-to-analog converter, a data voltage generation circuit), a data line driving circuit 34 and a scanning drive control section 36.

The shift register 22 includes flip-flops each corresponding to each of the data lines. The flip-flops are sequentially connected to one another. The shift register 22, upon retaining an enable I/O signal EIO at the leading flip-flop, operates in synchronism with a dot clock signal DCLK and sequentially shifts the enable I/O signal EIO to an adjacent one of the flip-flops.

The line latch 24 includes a latch (an image data resister) corresponding to each of the data lines. Grayscale data DIO from the display controller 40 is inputted in the line latch 24. Each of the latches of the line latch 24 latches image data corresponding to each of the data lines in synchronism with the sequentially shifted enable I/O signal EIO inputted from the shift register 22.

The line latch 26 latches grayscale data latched by the line latch 24 for the unit of one horizontal scanning, in synchronism with horizontal synchronization signals LP supplied from the display controller 40.

The multiplexer circuit 28 time-division multiplexes the grayscale data corresponding to each of the data lines inputted from the line latch 26, and generates time-division multiplexed grayscale data corresponding to each of the data voltage supply lines SR, SG and SB (S1-Sk).

The scanning drive control section 36 generates clock signals CLK for scanning drive which specify the time-division timings for scanning drive. Specifically, the scanning drive control section 36 generates n clocks for sequentially driving the first-n-th blocks in each one horizontal scanning period. Then the multiplexer circuit 28 receives the CLK and time-division multiplexes grayscale data for the first-n-th blocks. Also, the shift register SF of the liquid crystal panel 12 receives the CLK, and sequentially on/off controls the switch elements in the first-n-th blocks.

The grayscale voltage generation circuit 30 (a reference voltage generation circuit) generates grayscale voltages (reference voltages), and supplies the grayscale voltages to the DAC 32.

The DAC 32 (D/A converter circuit) generates data voltages (source voltages) to be supplied to each of the data lines (each of the source lines). More specifically, the DAC 32 selects one of the grayscale voltages provided from the grayscale voltage generation circuit 30 based on the digital grayscale data provided from the multiplexer circuit 28, and outputs the selected grayscale voltage as an analog data voltage.

The data line driving circuit 34 buffers the data voltages from the DAC 32 and drive the data lines. For example, the data line driving circuit 34 includes a driver circuit provided for each of the data lines (for example, the data line driving circuit shown in FIG. 2 described above).

### 5. Electronic Apparatus

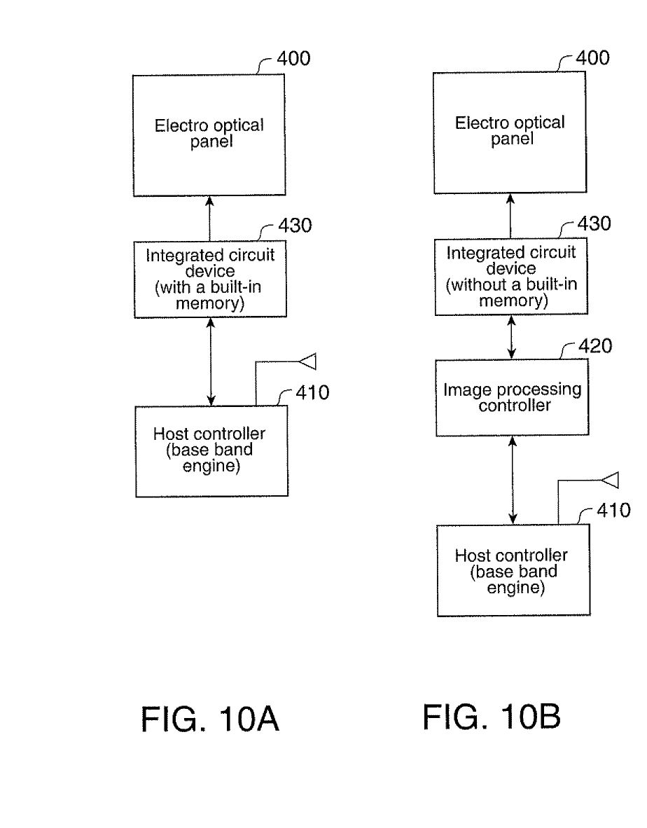

FIGS. 10A and 10B show exemplary compositions of a portable telephone (an electronic apparatus) that includes the integrated circuit device in accordance with an embodiment of the invention. According to the embodiment of the invention, many modifications including omission of a portion of the components shown in FIG. 10A or FIG. 10B, addition of other components thereto (for example, a camera, an operation section or a power supply and the like), and the like can be made. Moreover, the electronic apparatus in accordance with the embodiment of the invention is not limited to a portable telephone, but may be a digital camera, a PDA, an electronic notebook, an electronic dictionary, a projector, a rear projection type TV, or a portable information terminal.

A host controller 410 shown in FIG. 10A and FIG. 10B may be, for example, a micro processing unit (MPU), a base band engine or the like. The host controller 410 controls an integrated circuit device 430 that is the driver. Further, the host controller 410 may perform processings as an application engine or a base band engine, and perform processings as a graphic engine, such as, compression, expansion, sizing and the like. Also, an image processing controller 420 shown in FIG. 10B may act as the host controller 410, and performs processings as a graphic engine, such as, compression, expansion, sizing and the like.

The example shown in FIG. 10A may use the integrated circuit device 430 with a built-in memory. In this case, the integrated circuit device 430 temporarily writes image data sent from the host controller 410 to the built-in memory, and reads written image data from the built-in memory, thereby driving an electro optical panel 400. On the other hand, the example shown in FIG. 10B may use the integrated circuit device 430 without a built-in memory. In this case, image data from the host controller 410 is written to a built-in memory of the image processing controller 420. Then, the integrated circuit device 430 drives the electro optical panel 400 under the control of the image processing controller 420.

It is noted that, although some embodiments of the invention have been described in detail above, those skilled in the art would readily appreciate that many modifications are possible without departing in substance from the novel matter and effects of the invention. Accordingly, such modifications are deemed to be included within the scope of the invention. For example, throughout the specification and the drawings, any terms (input capacitor, feedback capacitor, ground voltage, driver, liquid crystal panel, liquid crystal display device and the like) described at least once with other different terms (first capacitor, second capacitor, first power supply voltage, integrated circuit device, electro optical panel, electro optical device, and the like) that encompass broader meaning or are synonymous can be replaced with these different terms in any sections of the specification and the drawings. Also, the structures and operations of the data line driving circuit, the D/A converter circuit, the driver circuit, the power supply circuit, the grayscale voltage generation circuit, the integrated circuit device, the electro optical device, the electronic apparatuses and the like are not limited to those described in the present embodiments, and many modifications can be made.

What is claimed is:

1. An integrated circuit device comprising:
a grayscale voltage generation circuit that outputs a plurality of grayscale voltages; and
a plurality of driver circuits that drive a plurality of data lines upon receiving the plurality of grayscale voltages,
wherein the grayscale voltage generation circuit voltage-divides between a high voltage side power supply voltage and a ground voltage thereby generating the plurality of grayscale voltages,
each of the plurality of driver circuits includes a data line driving circuit having a first capacitor and a second capacitor,
wherein the data line driving circuit performs an inversion-amplification of a gain according to a capacitor ratio between the first capacitor and the second capacitor, thereby outputting data voltages in an output range whose lower limit voltage is higher than the ground voltage.

2. An integrated circuit device according to claim 1, wherein the data line driving circuit has an operational amplifier having a first input terminal whose node is a summing node and an output terminal whose node is an output node, the first capacitor is provided between an input node of the data line driving circuit and the summing node, and the second capacitor is provided between the output node and the summing node.

3. An integrated circuit device according to claim 1, wherein the data line driving circuit performs the inversion amplification with an analog reference voltage higher than the ground voltage as a reference.

4. An integrated circuit device according to claim 3, wherein the data line driving circuit outputs a data voltage VQ=VA−C1/C2×(VIN−VA), where C1 is a capacitance value of the first capacitor, C2 is a capacitance value of the second capacitor, VA is the analog reference voltage, and VIN is an input voltage inputted in the data line driving circuit.

5. An integrated circuit device according to claim 3, wherein the analog reference voltage VA is set as VA=VDDRH/(1+C1/C2), where C1 is a capacitance value of the first capacitor, C2 is a capacitance value of the second capacitor, and VDDRH is the upper limit voltage in the output range of the data voltages that are outputted by the data line driving circuit.

6. An integrated circuit device according to claim 1, wherein the high voltage side power supply voltage VDDRW is set as VDDRW=C2/C1×(VDDRH−VDDRL), where C1 is a capacitance value of the first capacitor, C2 is a capacitance value of the second capacitor, VDDRH is the upper limit voltage and VDDRL is the lower limit voltage in the output range of the data voltages that are outputted by the data line driving circuit, wherein the grayscale voltage generation circuit generates the plurality of grayscale voltages by voltage-dividing between the high voltage side power supply voltage VDDRW and the ground voltage.

7. An integrated circuit device according to claim 6, wherein C1≧C2.

8. An integrated circuit device according to claim 2, wherein the data line driving circuit has a first switch element provided between the input node and a first node, a second switch element provided between the first node and a node of an analog reference voltage, a third switch element provided between the second node and the output node, a fourth switch element provided between the second node and the node of the analog reference voltage, and a fifth switch element provided between the summing node and the output node; the first capacitor is provided between the first node and the summing node; and the second capacitor is provided between the summing node and the second node.

9. An electro optical device comprising the integrated circuit device recited in claim 1.

10. An electronic apparatus comprising the integrated circuit device recited in claim 1.
